(19) United States
(12) Patent Application Publication
(10) Pub. No.: US 2002/0113959 A1
(43) Pub. Date: Aug. 22, 2002

(54) Method and apparatus for inspecting resist pattern

(75) Inventors: Mitsuru Uda, Kouga Gun Shiga (JP); Kazunari Terakawa, Youkaichi-Shi (JP); Akira Suzuki, Ohmihachiman City (JP)

Correspondence Address: IBM Corporation, 2070 Rt. 52, IPLaw - Zip 482, Hopewell Junction, NY, 12533, US

(73) Assignee: International Business Machines Corporation, Armonk, NY

(21) Appl. No.: 10/045,377

(22) Filed: Nov. 9, 2001

(30) Foreign Application Priority Data
Nov. 10, 2000 (JP) 2000-344026

(51) Int. Cl. G01N 21/00

(52) U.S. Cl. 356/237.5

(57) ABSTRACT

A method and apparatus for inspecting a resist pattern formed on an anti-reflection coating to detect defects by applying light to the resist pattern and visually observing light diffracted from the resist pattern. Light is applied to the resist pattern from a light source at an incident angle of 45 degrees or less with respect to the top surface of the resist pattern. An inspector positioned on the same side as the light source determines the presence or absence of a defective portion of the resist pattern by visually observing light diffracted to the same side as the light source. The defective portion of the resist can be visually distinguished from the non-defective portion by the brightness and color of the light diffracted to the same side as the light source.

### BACKGROUND OF THE INVENTION

1. Field of the Invention

The present invention relates to a method and apparatus for inspecting a resist pattern, formed on an antireflection coating, to detect defects. More particularly, the invention is directed to a method and apparatus for inspecting a resist pattern formed on an antireflection coating to detect the presence of defects by applying light to the resist pattern and visually checking diffracted light from the pattern.

2. Description of the Related Art

In the process of producing a semiconductor device, a resist pattern is formed on a substrate, such as a wafer, as a mask for forming a circuit pattern on the substrate. The resist pattern is formed by laying a predetermined mask on a resist applied to the wafer, exposing the pattern to light, and then removing the exposed part (or unexposed part) of the resist.

However, a part of the resist pattern is often not properly formed due to local de-focusing, i.e., an out-of-focus condition, caused in an expose step. If there is foreign matter, such as debris and dust, between the back surface of a wafer and a stage which holds the wafer by a vacuum chuck in an expose step, the surface of the wafer will not be flat. Further, if the resist is applied unevenly on the wafer or if there is foreign matter between the resist and the wafer, the height of the resist surface will become uneven. Local de-focusing may occur in such cases, which may result in the deformation of the resist pattern.

When a circuit pattern is formed on a wafer using a partially de-focused resist pattern as a mask, the line width of the circuit pattern formed on the de-focused part may be different from that of the circuit pattern formed on the properly focused part. Such a difference in line width has an adverse effect on circuit properties such as resistance. For example, where the gate or channel length of a field effect transistor (FET) is shortened due to de-focusing, characteristics of the transistor will vary from the original design.

If a de-focused portion of a resist pattern can be detected before forming a circuit pattern on a wafer, the resist pattern can be stripped off the wafer so as to reform another resist pattern thereon. In this case, the wafer is reusable. On the other hand, if the de-focused part of the resist pattern fails to be detected before forming a circuit pattern, circuit defects caused by the de-focused resist pattern may be detected in a later step of electrical testing of circuit operations after forming a circuit pattern on the wafer. In this case, the circuit pattern has already been formed on the wafer, so that the wafer cannot be reused. Thus, early detection of a de-focused pattern of resist is of great importance for improvements in yield.

One of the typical methods for inspecting a resist pattern for defects caused by de-focusing is a visual inspection method. In the visual inspection method, as shown in FIG. 10(a), an inspector P visually checks zero-order diffracted light Lt(0) which is the light reflected from a resist pattern 12 when light Lin from a light source device S is applied to the pattern 12. In this case, the resist pattern 12 is formed on a wafer 16, and the inspector P is on the opposite side of the light source device S.

FIG. 10(b) is an enlarged view of the resist pattern 12. The inspector P visually checks the reflected light Lt(0) from the top surface 12t of the resist pattern 12. The light Lin is also reflected by the surface 16t of the wafer 16. However, in most cases, the intensity of the reflected light Lt(0) from the top surface 12t of the resist pattern 12 is more than twice as high as that of the reflected light from the surface 16t of the wafer 16. Thus, the inspector P mainly inspects the reflected light Lt(0) from the top surface 12t.

As shown in FIG. 11(a), the top surface area 92t of a de-focused resist pattern 92 is different in size from the top surface area 12t of the normal or focused resist pattern shown in FIG. 10(c), so that the amount of light reflected by the surface 92t is also different from the amount of light reflected by the surface 12t. Since a de-focused part looks darker than a normal part, the de-focused part can be distinguished from the normal part by brightness.

With the advance of finer feature semiconductor development, a circuit pattern having a line width of 0.3 microns or less is increasing. In general, when the resist pattern having a line width of 0.3 microns or less is formed, the resist is exposed to laser light whose light source is a krypton fluoride (KrF) excimer laser operating at a wavelength of 246 nanometers rather than lamp light whose light source is typically an extra-high pressure mercury lamp. However, unlike lamp light, laser light is coherent, so that standing waves can be easily generated, as shown in FIG. 11(b). The standing waves are generated by interference of incident light to the wafer 16 and reflected light from the wafer surface 16t. The side surface of the resist pattern 94 is deformed by the standing waves, which adversely affect the formation accuracy of a circuit pattern.

In order to prevent the generation of standing waves, an antireflection coating 14 is formed as a base layer, as shown in FIG. 11(c). The antireflection coating 14 absorbs the incident light and reduces the transmission and reflection of the light. FIG. 12(a) is a line graph showing a relationship between a wavelength and a reflectance of the incident light to the coating 14. The coating 14 reflects little light with a wavelength of 248 nanometers from the excimer light. Thus, the coating 14 can reduce the reflection of excimer laser light and prevent the generation of standing waves.

However, as is shown in FIG. 12(a), there is almost no difference in reflectance between the resist and the coating 14 in a visible region. FIG. 12(b) is a line graph showing a relationship between an incident angle and a reflectance of the incident light to the coating 14 and resist. As can be seen from FIG. 12(b), the coating 14 and resist have substantially the same reflecting properties. In FIG. 12(a), an incident angle is perpendicular to the surface of the coating, and in FIG. 12(b) a wavelength of the incident light is 50 nanometers. In these figures, a resist M20G (JSR Corporation) having a thickness of 898 Å and an antireflection coating AR3 (Shipley Company L. L. C.) having a thickness of 5567 Å were used.

Since the coating 14 and the resist have the same reflectance regardless of the incident angle and the wavelength, the intensity of light reflected from the surface of the coating 14 is equal to that of light reflected from the surface of the resist. Therefore, since it is difficult to distinguish the light reflected from the resist surface 12t from the light reflected from the coating surface 14t, visual inspection of the resist pattern 12 for de-focus defects cannot be conducted.

An object of the present invention is to inspect a resist pattern formed on an antireflection coating to detect defects by applying light to the resist pattern and visually checking diffracted light from the pattern.

### BRIEF SUMMARY OF THE INVENTION

An apparatus for inspecting a resist pattern to detect the absence or presence of defects by applying light to the pattern and visually checking diffracted light from the pattern according to the present invention comprises a light source device for applying light to the resist pattern at an incident angle of 45 degrees or less with respect to the top surface of the resist pattern. By setting an incident angle of 45 degrees or less, light can be applied to the side surface of the resist pattern and then diffracted light from the side surface can be viewed from the side of the light source device.

A method of inspecting a resist pattern to detect the absence or presence of defects by applying light to the resist pattern and visually checking diffracted light from the pattern, according to the present invention, comprises the steps of: applying light from a light source to the resist pattern at an incident angle of 45 degrees or less with respect to the top surface of the resist pattern, and detecting the presence or absence of defects of the resist pattern by visually checking the diffracted light from the resist pattern, which travels back to the side of the light source.

In the present invention, by applying light at an incident angle of 45 degrees or less with respect to the top surface of the resist pattern, the minus first-order diffracted light from the side surface of the resist pattern can travel to the side of the light source device. Therefore, the inspector on the same side as the light source device can see the minus first-order diffracted light, whereby a resist pattern formed on an antireflection coating can be inspected to detect defects caused by de-focusing.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows in conjunction with the accompanying drawings in which:

FIGS. 1(a)-1(d) show an apparatus and method for inspecting a resist pattern according to the present invention.

FIG. 1(a) is a schematic view of an inspection of a resist pattern.

FIG. 1(b) is a schematic view of details of the resist pattern taken from FIG. 1(a).

FIG. 1(c) shows an example of a light source portion.

FIG. 1(d) shows another example of a light source portion.

FIGS. 2(a) and 2(b) show a direction of the application of light to the resist pattern.

FIG. 2(a) is a top view of a wafer.

FIG. 2(b) is a side view of the wafer.

FIGS. 3(a) and 3(b) show an example of diffracted light from the resist pattern.

FIG. 3(a) is a view showing that minus first-order diffracted light does not travel to an inspector.

FIG. 3(b) is a view showing that minus first-order diffracted light travels to the inspector.

FIG. 4 shows an example of a relationship between an incident angle and a minus first-order diffraction angle with respect to the side surface of the resist pattern.

FIGS. 5(a) and 5(b) show an example of a relationship between a wavelength and the minus first-order diffraction angle of incident light.

FIG. 5(a) shows the incident angle at 30 degrees.

FIG. 5(b) shows the incident angle at 1 degree.

FIGS. 6(a) and 6(b) show a difference in incident angle between a normal resist pattern and a de-focused resist pattern.

FIG. 6(a) is a side view showing the normal resist pattern and the de-focused resist pattern.

FIG. 6(b) is a side view showing a difference in incident angle between the normal resist pattern and the de-focused resist pattern.

FIGS. 7(a) to 7(c) show an application of light to a resist pattern.

FIG. 7(a) shows a diffusion of an incident light.

FIG. 7(b) shows a change in the incident angle caused by the diffusion of the incident angle.

FIG. 7(c) shows that an incident angle changes according to a position of the light source portion.

FIG. 8 shows an example of a relationship between a diffusion angle and a minus first-order diffraction angle of an incident light.

FIG. 9 shows a wavelength distribution of a halogen lamp.

FIG. 10(a) and 10(b) show an example of a conventional apparatus and method for inspecting a resist pattern.

FIG. 10(a) is a schematic view showing a conventional method for inspecting a resist pattern.

FIG. 10(b) is a schematic view of details of the resist pattern taken from FIG. 10(a).

FIG. 11(a) shows an example of a de-focused resist pattern.

FIG. 11(b) shows an example of a resist pattern having no antireflection coating.

FIG. 11(c) shows an example of a resist pattern having an antireflection coating.

FIG. 12(a) is a line graph showing an example of a relationship between a wavelength and a reflectance of an incident light to a resist pattern and to an antireflection coating.

FIG. 12(b) is a line graph showing an example of a relationship between an incidental angle and a reflectance of an incident light to the resist pattern and to the antireflection coating.

### DETAILED DESCRIPTION OF THE INVENTION

An embodiment of the present invention will be described with reference to the accompanying drawings, taking, as an example, an inspection of a resist pattern formed on an antireflection coating applied onto a wafer to detect defects. In this embodiment, a resist M20G (JSR Corporation) having a thickness of 898 Å and an antireflection coating AR3 (Shipley Company L. L. C.) having a thickness of 5567 Å was used. The refractive indexes of the resist and the antireflection coating may vary depending on the wavelength of an incident light, but the refractive indexes range from 1.5 to 1.7 in a visible region. Both the width of the resist pattern and the spacing between resist patterns is 0.3 microns.

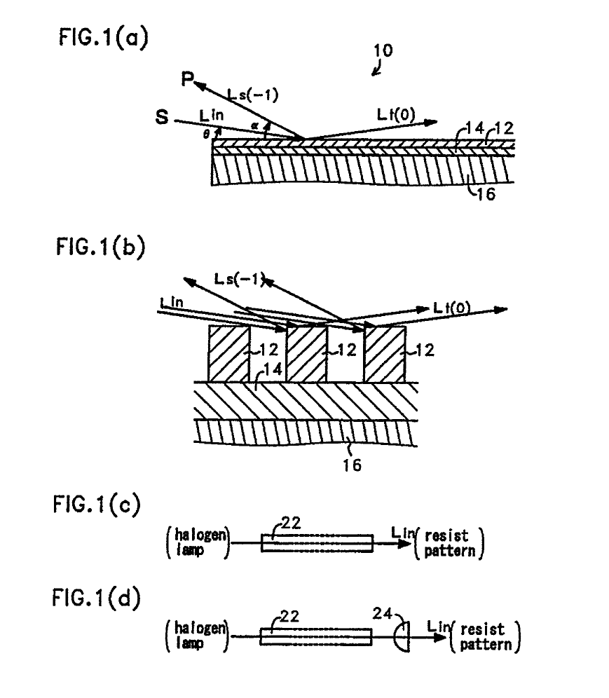

FIG. 1(a) shows an example of an apparatus 10 for inspecting a resist pattern according to the present invention. In the apparatus 10, light Lin is applied to a resist pattern 12 from a light source device S and an inspector P visually checks light Ls(−1) diffracted by the resist pattern 12. In a conventional inspection, the inspector P is on the opposite side from a light source device S, but in the present invention, the inspector is on the same side as the light source device S.

FIG. 1(b) is an enlarged view showing the resist pattern 12 according to the present invention. In a conventional inspection, zero-order diffracted light (reflected light) Lt(0) from the top surface of the resist pattern 12 is visually checked, but in the present invention, diffracted light Ls(−1) from the side surface of the resist pattern 12 is visually checked. In the invention, the diffracted light to be inspected is not reflected light (zero-order diffracted light) but minus first-order diffracted light which will be described later.

The inspection apparatus 10 comprises a light source device S and a rotatable stage (not shown) for placing a wafer 16 thereon. The light source device S applies light to the resist pattern 12 at an incident angle θ of 45 degrees or less with respect to the top surface of the resist pattern 12. The incident angle θ is within a range in which the inspector P can visually check the minus first-order diffracted light Ls(−1).

The incident light Lin to be applied by the light source device S includes visible light for visual inspection. For example, the light source may be a halogen lamp. As shown in FIG. 1(c), the light source device S comprises a halogen lamp as a light source and an optical fiber 22 through which light from the halogen lamp passes.

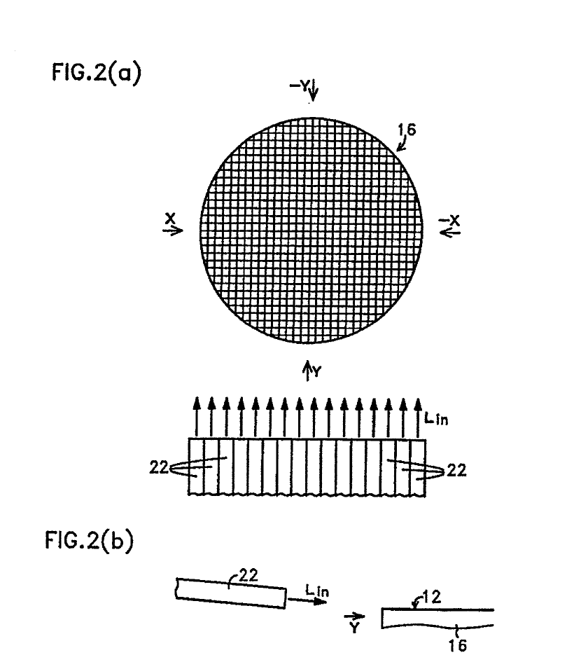

In a conventional inspection, the optical fiber is also used for guiding a light from the light source. However, in most cases, the divergence angle of the light from the optical fiber is 70 degrees or more so as to illuminate the whole wafer brightly enough by diverging the light. However, in the present invention, an optical fiber 22 having a divergence angle of 10 to 60 degrees is used. The divergence angle is within a range in which a de-focused part and a normal or focused part can be distinguished from each other. The optical fiber 22 having a divergence angle of 10 to 60 degrees can be produced by changing the composition ratio of materials in the fiber to adjust the refractive index of the fiber. The divergence angle of the optical fiber 22 is narrower and the incident angle θ is lower than conventional, so that a plurality of optical fibers 22 are arranged in line so as to apply incident light Lin to the whole wafer 16, as shown in FIG. 2(a).

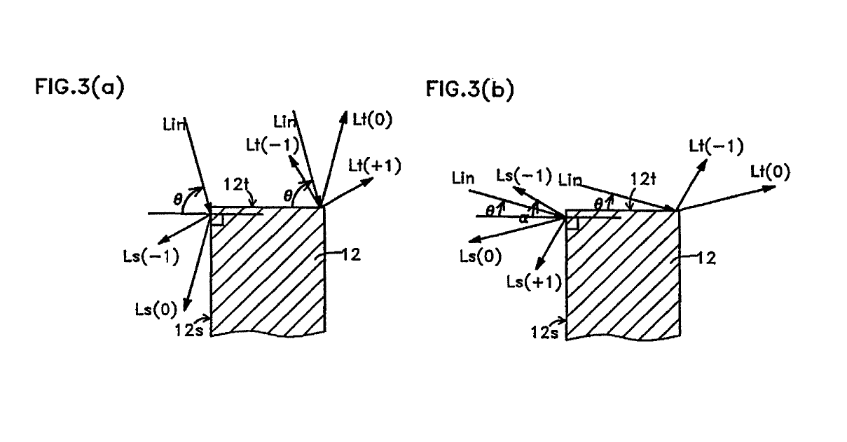

FIGS. 3(a) and 3(b) show an incident light Lin to, and a diffracted light from, the surface of the resist pattern 12. In the figures, Lt(0), Lt(+1), and Lt(−1) indicate zero-order, plus first-order, and minus first-order diffracted lights respectively from the top surface 12t of the resist pattern. Ls(0), Ls(+1), and Ls(−1) indicate zero-order, plus first-order, and minus first-order diffracted lights respectively from the side surface 12s of the resist pattern. The angles θ and α indicate an incident angle and a minus first-order diffraction angle with respect to a surface parallel to the top surface 12t of the resist pattern, respectively.

As shown in FIG. 3(a), the first-order diffracted lights Lt(+1) and Lt(−1) are symmetric with respect to the zero-order diffracted light Lt(0). In this specification, the first-order diffracted light which travels farther away from the light source device S than the zero-order diffracted light Lt(0) is defined as plus first-order diffracted light Lt(+1) and the other is defined as minus first-order diffracted light Lt(−1).

FIG. 3(a) shows a case where an incident light Lin is applied at an incident angle θ of 75 degrees. As shown in FIG. 3(a), the zero-order diffracted light Ls(0) and the minus firs-order diffracted light Ls(−1) from the side surface 12s of the resist pattern travel to the side of the antireflection coating 14 (below the top surface 12t of the resist pattern). In this case, the inspector P cannot visually check the minus first-order diffracted light Ls(−1) from the side surface 12s of the resist pattern.

FIG. 3(b) shows a case where an incident light Lin is applied at an incident angle θ of 30 degrees. As shown in FIG. 3(b), the zero-order diffracted light Ls(0) from the side surface 12s of the resist pattern travels to the side of the antireflection coating 14 (below the top surface 12t of the resist pattern), while the minus first-order diffracted light Ls(−1) travels to the side of the light source device S (above the top surface 12t of the resist pattern). In this case, the inspector P can visually check the minus first-order diffracted light Ls(−1) from the side surface 12s of the resist pattern.

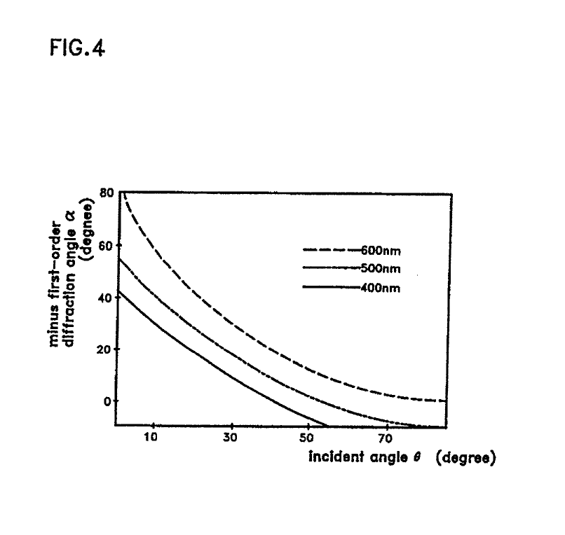

FIG. 4 shows a relationship between the incident angle θ and the minus first-order diffraction angle α.. The minus first-order diffraction angle α should be larger than 0 degrees so that the inspector P can view it by eye. The minus first-order diffraction angle α varies according to a wavelength of the incident light. When the incident angle θ is 45 degrees or less, the inspector P can visually check the minus first-order diffracted light Ls(−1) in a wavelength range of 400 to 600 nm.

The smaller the incident angle θ, the larger the minus first-order diffraction angle α, and consequently the inspector P can easily view the minus first-order diffracted light by eye. However, when the incident angle θ is around 0 degrees, the inspector cannot see the minus first-order diffracted light at a wavelength of around 600 nanometers. For this reason, the incident angle θ is preferably about 5 degrees so that the inspector can also see the minus first-order diffracted light at a wavelength of around 600 nanometers. In one embodiment, the incident angle θ is set to 5 degrees.

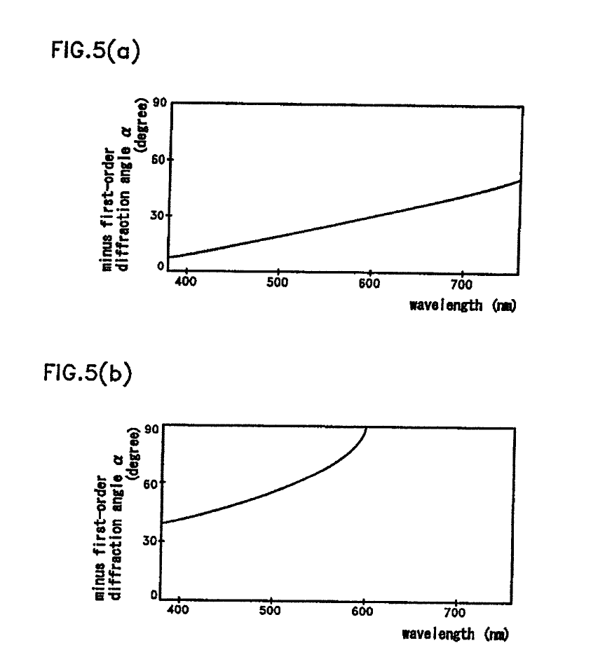

Even if the lights are applied at the same incident angle θ, the minus first-order diffraction angle a varies according to a wavelength of the incident light. FIG. 5(a) shows a relationship between a wavelength and a minus first-order diffraction angle a when an incident angle θ is 30 degrees. As shown in FIG. 5(a), the minus first-order diffraction angle α varies depending on the wavelength of the incident light. FIG. 5(b) shows a relationship between a wavelength and a minus first-order diffraction angle α when the incident angle θ is 1 degree. In this case, the inspector P can only view the light with a wavelength of 580 nanometers or less by eye.

As shown in FIG. 5(b), the wavelength of light which can be viewed by eye is limited by the incident angle θ. For this reason, only the light beams having a wavelength of 580 nanometers or less are used in the present invention. Therefore, a filter (not shown) is provided to the light source device for removing light having a wavelength of greater than 580 nanometers.

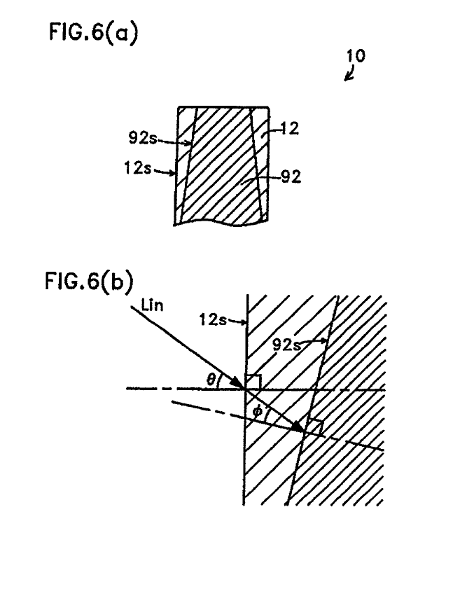

As shown in FIG. 6(a), the inclination of the side surface 12s of the normal, or focused, resist pattern 12 is different from the inclination of the side surface 92s of the de-focused resist pattern 92. As shown in FIG. 6(b), even when the same light Lin is incident, the incident angle ψ to the side surface 92s of the de-focused resist pattern is different from the incident angle θ to the side surface 12s of the normal resist pattern. The minus first-order diffracted light varies according to the incident angle.

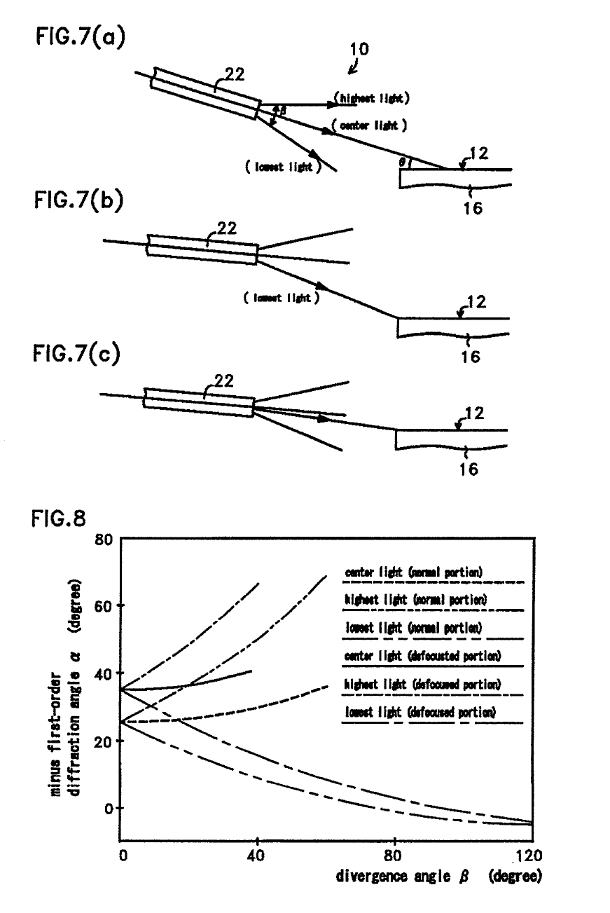

As shown in FIG. 7(a), a light beam from an optical fiber 22 diverges symmetrically with respect to the center axis of the optical fiber 22 within an angle β. In FIG. 7(a), the angle β is referred to as a “divergence angle”, the light beam traveling along the center axis of the optical fiber 22 is referred to as a “center light beam”, the light beam which is the nearest to the wafer 16 is referred to as a “lowest light beam”, and the light beam which is the farthest away from the wafer 16 is referred to as a “highest light beam”. The diverged light beams are applied to the resist pattern 12. The incident angle θ is the incident angle of the center light beam.

The diverged light beams are applied to the resist pattern 12 at different incident angles. The minus first-order diffraction angle varies depending on the incident angle. Thus, the minus first-order diffracted light diverges symmetrically with respect to a center diffracted light beam within a range between a highest diffracted light beam and a lowest diffracted light beam. When the minus first-order diffracted light diverges within a certain range, the range of the inspector's eye position and direction within which the inspector can view the light by eye can be expanded. In contrast, when the incident light beam diverges within a narrow range, the minus first-order diffracted light also diverges within a narrow range. Therefore, the inspector's eye position and direction is hard to adjust. The divergence angle is preferably 10 degrees or more so that the inspector P can easily view the minus first-order diffracted light by eye.

FIG. 8 shows a relationship between the divergence angle β and the minus first-order diffraction angle a of an incident light. In this case, the incident angle θ of the center light beam is 30 degrees, the wavelength of the incident light is 550 nanometers, the difference in inclination between the side surface 12s of the normal resist pattern 12 and the side surface 92s of the de-focused resist pattern 92 is 9 degrees. The light with a wavelength of 550 nanometers is easy to see by eye. However, when the divergence angle β is more than 60 degrees, the center light beam of the minus first-order diffracted light from the normal or focused part becomes hard to see by eye. The intensity of the center light beam decreases with an increase of the divergence angle β to and the divergence range of the diffracted light from the normal or focused part overlaps that of the diffracted light from the de-focused part, so that the center diffracted light can be hardly distinguished from other diffracted light by eye. For this reason, the divergence angle must be 60 degrees or less so as to be able to view the center diffracted light by eye. In combination with the preferable divergence angle of 10 degrees or more, as described above, the divergence angle should be 10 to 60 degrees.

As shown in FIG. 8, when the divergence angle β is 40 degrees or more, the center light beam of the minus first-order diffracted light from the de-focused part cannot be viewed by eye. For this reason, the divergence angle β is preferably 35 degrees or less so as to be able to view the center diffracted light from the de-focused portion. In this embodiment, the divergence angle β is set to 35 degrees, and a multi-component glass fiber is used as the optical glass fiber 22.

In the present invention, the incident angle of the center light beam is set to 5 degrees. As shown in FIG. 7(b), when the resist 12 is illuminated by the optical fiber 22 which is placed at a much higher position than the top surface of the resist pattern 12, only the light portion in a range from the center light beam to the lowest light beam is applied to the resist pattern 12. The center light beam has the highest intensity, while the highest and lowest light beams have the lowest intensity. Since a higher-intensity light beam is easier to see by the inspector, it is preferred to apply the light beams close to the center beam to the resist pattern.

As shown in FIG. 7(c), when the resist pattern 12 is illuminated by the optical fiber 22 which is substantially as high as the top surface of the resist pattern 12, only the light beams close to the center light beam are applied to the resist pattern 12. In the present invention, the light is applied to the resist pattern 12 by the optical fiber 22 which is placed at a position substantially as high as the top surface of the resist pattern, as shown in FIG. 2(b). Preferably, the optical fiber 22 is so placed that the center light beam can be applied to the resist pattern 12.

As shown in FIG. 2(a), the wafer 16 is finely divided into rectangular chips. A circuit pattern is formed in such a manner that it extends in parallel with the direction in which the chips are cut. The light should be applied from a direction perpendicular to the direction in which the resist pattern 12 extends. As shown in FIG. 2(a), the light is applied from an X direction or −X direction and from a Y direction or −Y direction. The direction of the application of the light Lin can be adjusted by rotating a stage (not shown) for placing a wafer 16 thereon.

Since resist is photosensitized by the application of light having a wavelength of less than 480 nanometers, a filter (not shown) is provided to the light source device to filter out light beams having a wavelength of less than 480 nanometers. As described above, the filter for filtering out light beams having a wavelength of greater than 580 nanometers is also provided to the light source device, so that the light beams having a wavelength of 480 to 580 nanometers are applied to the resist pattern 12.

As shown in FIG. 1(d), a cylindrical lens 24 can also be provided near the end of the optical fiber 22 so as to increase a directivity of light. Even if the divergence angle of the optical fiber 22 is more than 60 degrees, the cylindrical lens 24 can reduce the diffusion angle to 60 degrees or less.

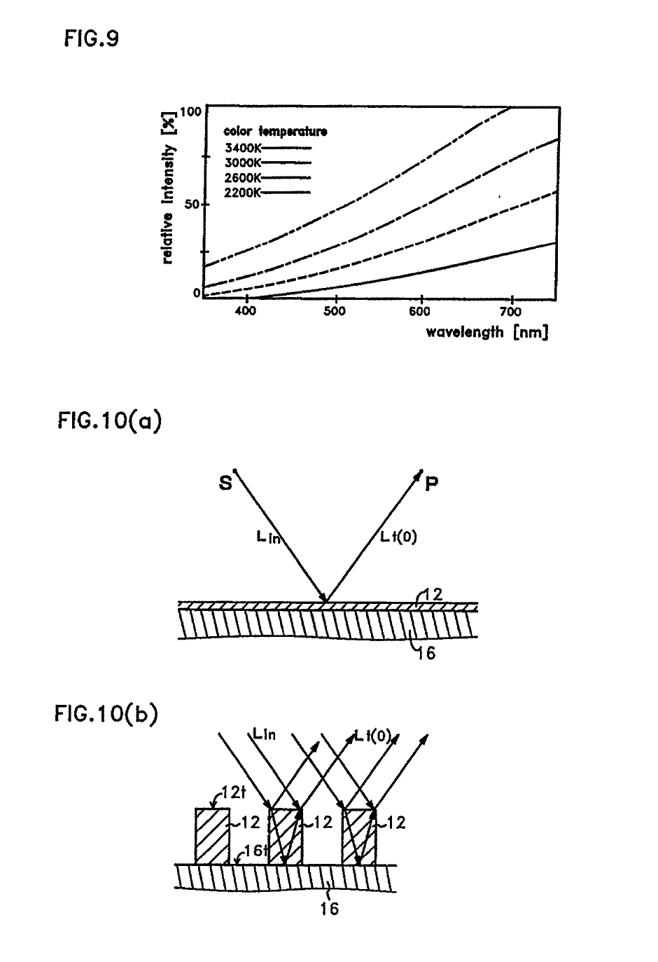

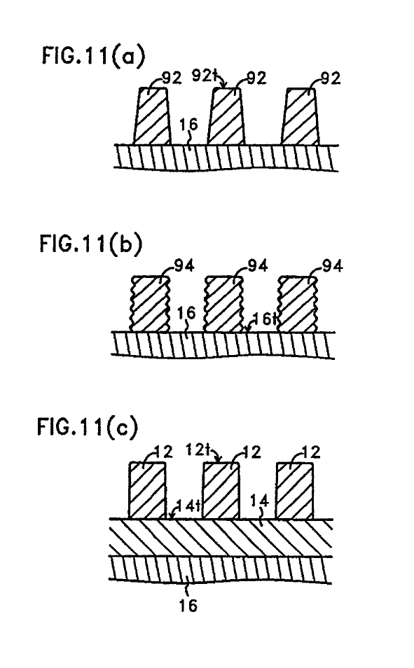

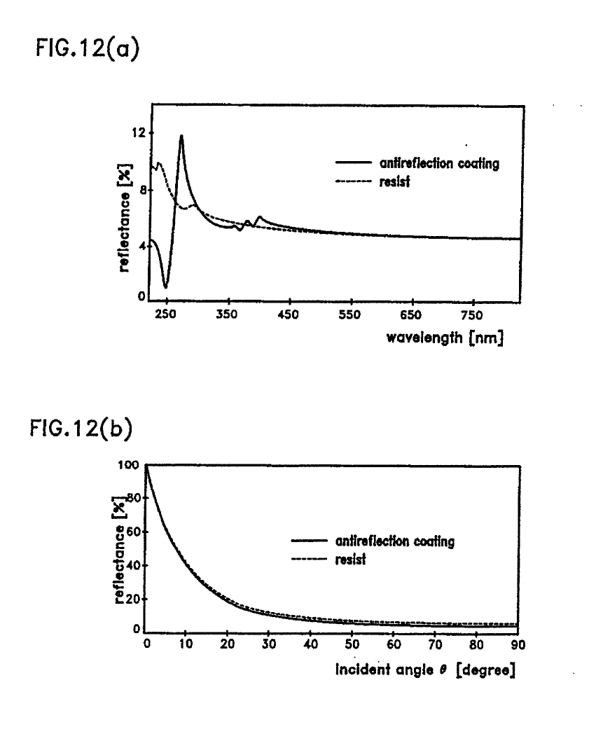

As shown in FIG. 9, light intensity of a halogen lamp is distributed over a wide wavelength region. As shown in FIGS. 4, 5(a) and 5(b), when the incident angle θ is constant, the minus first-order diffraction angle α varies depending on the wavelength. In contrast, when the minus first-order diffraction angle α is constant, the wavelength varies depending on the incident angle θ. The incident angle to the normal or focused resist pattern is different from the incident angle to the de-focused resist pattern. Therefore, as far as the inspector keeps the eye position constant and the minus first-order diffraction angle α is constant, the normal or focused part and the de-focused part can be distinguished from each other by variations of wavelength, i.e., by color.

Next, an inspection of a resist pattern using the apparatus and method of the present invention will be described below.

In the present invention, light Lin is applied to the top surface 12t of a resist pattern 12 at an incident angle of 45 degrees or less, preferably 5 degrees. An inspector P is on the same side S as a light source device, and visually checks a minus first-order diffracted light Ls(−1) which is a part of a plurality of diffracted lights and goes back to the side S.

Light from a halogen lamp passes through an optical fiber 22 and then it is applied to the resist pattern 12 at a divergence angle of 10 tp 60 degrees, preferably 35 degrees. Where the divergence angle of the light from the optical fiber 22 is more than 60 degrees, a cylindrical lens can be additionally provided to the optical fiber to narrow the divergence angle to 10 to 60 degrees.

Of the light Lin from the light source device S, light components with wavelengths of less than 480 nm and greater than 580 nm are screened by a filter (not shown). As shown in FIG. 2(b), the optical fiber 22 illuminates the resist pattern 12 from a height substantially the same as, or slightly higher than, the top surface of the resist pattern 12. As shown in FIG. 2(b), the light is applied to the resist pattern 12 in a Y direction (or −Y direction, +X direction, or −X direction) perpendicular to the direction in which the resist pattern 12 extends.

As shown in FIG. 3(b), the side surface 12s of the resist pattern generates a minus first-order diffracted light Ls(−1). Where the minus first-order diffraction angle α is larger than 0 degrees, the inspector P can view the minus first-order diffracted light Ls(−1) by eye. As shown in FIG. 6(b), since an inclination angle is different between the side surface 12s of the normal or focused resist pattern and the side surface 92s of the de-focused resist pattern, incident angles θ and ψ are also different, whereby the minus first-order diffraction angle α is different between them.

The diffraction angle is different between the side surface 12s of the normal or focused resist pattern and the side surface 92s of the de-focused resist pattern. Thus, if the minus first-order diffracted light Ls from the normal part travels to the inspector P, then the minus first-order diffracted light from the de-focused part will travel in the direction deviated from the inspector P. Therefore, the normal or focused part and de-focused part can be distinguished from each other by the brightness of the minus first-order diffracted light Ls(−1). A portion of the resist pattern with a different brightness from the normal or focused portion is determined as the de-focused portion of the resist pattern.

The light Lin to be applied to the resist pattern 12 comprises light beams of different colors. As shown in FIG. 4, when the minus first-order diffraction angle α is constant, the wavelength giving the constant angle varies according to the incident angle. The color of light to be viewed by the inspector varies according to the wavelength. Thus, the normal or focused part and de-focused part can be distinguished from each other by color difference of the minus first-order diffracted light Ls(−1). A portion of the resist pattern having a different color from the normal or focused part is determined as the de-focused part. The different colors viewed for the normal or focused and de-focused parts are preferably complementary colors such as red and green rather than similar colors such as red and violet.

In this way, even a de-focused part of the resist pattern 12 formed on an antireflection coating 14 can be inspected by visually inspecting the minus first-order diffracted light Ls(−1) from the side surface 12s of the resist pattern. The de-focused part can be distinguished from the normal or focused part by brightness and color of the minus first-order diffracted light Ls(−1).

One embodiment of the present invention has thus been described, however, the present invention is not limited to this particular embodiment. The present invention is not limited to the detection of defects caused by de-focusing, but can be applied to the detection of foreign matter and scratches, for example. Since foreign matter and scratches cause a scattering of light, the presence or absence of foreign matter and scratches can be visually checked by the scattered light.

The light source is not limited to a halogen lamp, but any light source such as a xenon lamp can be used, as far as it emits visible light. Further, instead of visual inspection, a de-focused part can be detected by a CCD (charge coupled device) which receives minus first-order diffracted light and image-processes the received light. In addition, various changes, modifications, and improvements can be made to the embodiments on the basis of knowledge of those skilled in the art without departing from the scope of the present invention.

What is claimed is:

1. An apparatus for inspecting a resist pattern to detect defects by applying light to the resist pattern and visually checking light diffracted from the resist pattern, the apparatus comprising:
a light source device for applying light to the resist pattern at an incident angle of not greater than 45 degrees with respect to a top surface of the resist pattern.

2. The apparatus according to claim 1, wherein said light source device comprises:
a light source; and
means for narrowing a divergence angle of light from the light source to 10 to 60 degrees.

3. The apparatus according to claim 2, wherein said means for narrowing the divergence angle includes an optical fiber.

4. The apparatus according to claim 3, wherein said means for narrowing the divergence angle further includes a cylindrical lens for passing light from the optical fiber therethrough.

5. The apparatus according to claim 4, further comprising:
means for adjusting a direction of light applied from said light source device to a direction perpendicular to the direction in which the resist pattern extends.

6. The apparatus according to claim 5, wherein light from said light source device includes visible light.

7. The apparatus according to claim 6, wherein said visible light includes only light with a wavelength of at least 480 nanometers.

8. The apparatus according to claim 6, wherein said visible light includes only light with a wavelength of not greater then 580 nanometers.

9. The apparatus according to claim 6, wherein said visible light includes light of different colors.

10. The apparatus according to claim 2, wherein said light source is a halogen lamp.

11. A method of inspecting a resist pattern to detect defects by applying light to the resist pattern and visually checking light diffracted from the resist pattern, the method comprising the steps of:
applying light from a light source to the resist pattern at an incident angle of not greater than 45 degrees with respect to a top surface of the resist pattern; and
detecting the presence or absence of defects of the resist pattern by visually checking the diffracted light traveling back to the side of the light source from the resist pattern.

12. The method according to claim 11, wherein said step of applying light comprises a step of narrowing a divergence angle of light from the light source to 10 to 60 degrees.

13. The method according to claim 12, wherein said step of narrowing the divergence angle comprises passing the light from the light source through an optical fiber.

14. The method according to claim 13, wherein said step of narrowing the divergence angle comprises passing the light from the light source through a cylindrical lens.

15. The method according to claim 11, wherein said step of applying light comprises removing light with a wavelength of less than 480 nanometers.

16. The method according to claims 11, wherein said step of applying light comprises removing light with a wavelength of greater than 580 nanometers.

17. The method according to claim 11, wherein said step of applying light comprises applying light of different wavelengths.

18. The method according to claim 11, wherein said step of applying light comprises applying light from substantially the same height as the top surface of the resist pattern.

19. The method according to claim 11, wherein said step of applying light comprises applying light in a direction perpendicular to a direction in which the resist pattern extends.
